(19) United States
(12) Patent Application Publication
(10) Pub. No.: US 2007/0008890 A1
(43) Pub. Date: Jan. 11, 2007

(54) Method and apparatus for non-stop multi-node system synchronization

(76) Inventors: Eugene R. Tseitlin, Northbrook, IL (US); Stanislav N. Kleyman, Chicago, IL (US); Iouri A. Tarsounov, Buffalo Grove, IL (US)

Correspondence Address: MOTOROLA, INC., 1303 EAST ALGONQUIN ROAD, IL01/3RD, SCHAUMBURG, IL, 60196, US

(21) Appl. No.: 11/178,747

(22) Filed: Jul. 11, 2005

(51) Int. Cl. H04J 3/14

(52) U.S. Cl. 370/238; 709/223; 718/100

(57) ABSTRACT

A communication system (50) can include a source node (31) coupled to a peer node (41), a source database (38) and a target database (48) at the peer node, and a logical unit (32 or 42). The logical unit can be programmed to forward data changes from source to peer node, monitor a health status of a replication task (34 or 44) by performing an audit on the source and nodes, and compare the audits on the source and peer nodes. The logical unit can be further programmed to perform at least one among the functions of synchronizing by launching a replication task synchronization thread (52) and a new target database (54) at the peer node and replacing the target database with the new target database upon completion of the synchronizing or switching over to the peer node upon detection of a critical failure at the source node during synchronization.

### FIELD OF THE INVENTION

The present invention relates generally to a method and mechanism for providing a non-stop, fault-tolerant telecommunications system and, more particularly, to a method and mechanism which accommodates non-stop, fault tolerant telecommunications during database and replication system errors as well as during synchronization.

### BACKGROUND OF THE INVENTION

Highly Available (HA) systems are expected to provide continuous operation or service through system failures. In case of a failure it is important in such systems to quickly and efficiently recover any lost functionality. This assumes eliminating manual actions from the recovery process, as manual intervention delays the issue resolution significantly. One way to provide system high availability involves running the network elements in a bi-nodal architecture. In such a configuration, data stored on one node must also be preserved on another node via check-pointing or replication. Existing HA systems fail to efficiently handle database and replication system failures and also typically experience data losses. Furthermore, existing HA systems should synchronize the two nodes after any temporary inter-node communication outages. Again, existing HA systems fail to contemplate a graceful exit and recovery strategy if a system failure occurs while node synchronization is in progress in order to avoid system outages or data loss.

Most database management system vendors temporarily stop activity on an active node during their data synchronization. Furthermore, most database management system vendors prevent a switchover to a standby node when synchronization is in process in a dual node system

U.S. Pat. No. 6,286,112 B1 entitled “Method and Mechanism for providing a non-stop, fault-tolerant telecommunications system” by Tseitlin et al, hereby incorporated by reference, addresses task and queue failure issues, automatic tasks and queue updates, upgrades, replacement and recovery. In many cases the HA systems use dual node design to prevent system outages. Real-time HA Systems typically use real-time dynamic data replication or checkpointing to preserve data on both nodes in the dual-node system. U.S. Pat. No. 6,286,112 does not necessarily involve or discuss data storage failures and data replication failures which may result in the loss of service in a fault-tolerant system although some of the techniques discussed therein can be useful in some of the recovery techniques. Also, U.S. Pat. No. 6,286,112 does not necessarily address continuous data replication/checkpointing and dynamic data recovery methods.

### SUMMARY OF THE INVENTION

Embodiments in accordance with the present invention can provide a method and apparatus of online database region replacement with either a local or remote copy of a database utilizing a task controller concept with replication and/or synchronization services. Note, the database region can be used for real-time operation by one or many tasks in the system. The task controller, for example, as described in U.S. Pat. No. 6,286,112 B1 can have additional responsibilities of monitoring database region health and initiating region recovery and/or replacement actions when necessary. The controller task can control an entire synchronization process and can send SNMP notifications to the applicable region client tasks as well to any other tasks, nodes and network elements for full system coordination and synchronization.

In a first embodiment of the present invention, a method for task controller operation in a multi-nodal replication environment in a communication system can include the steps of controlling the process of forwarding data changes to a peer node from a source node, monitoring a health status of a replication task (and ensuring data consistency) by performing an audit on the source node and the peer node, and comparing the audit on the source node with the audit on the peer node. The method can further include the step of supervising continuous data replication and initiating a dynamic data recovery when failures are detected. Monitoring can be done by performing the audits on the source node and peer node using SNMP queries and can also be done by executing a random audit by a replication task that checks data stores at the source node and at the peer node. Note, the random audit can further include checking replication queues. As a result of the monitoring, confirmations can be sent back to the task controller using SNMP for example. Note, the multi-nodal environment can be a dual node or a multi-node system or a single node system that has additional copies of the data regions which are being used as back-up for the single node's main data region.

The method can further include the step of initiating synchronization upon determining an out of synchronization status. Synchronization can be initiated by one among a detection of a lost database on initialization, a detection of data corruption during run-time, and a user selected initiation as examples. Note, a task controller in an active-standby dual node configuration can enable a standby node among the source node and the peer node to process synchronization to reduce overhead on an active node. During synchronization, the method can further include the step of launching a new replication task instance on the target node for synchronization purposes of a new database region which can be populated with data from a source database from the source node. Note, that in a single node system, the source node and the target node are the same, but the source data region and the target data region can still exist, although on the same node. Further note, the synchronization process can occur between the source node and the standby node while the step of forwarding data changes to the peer node from the source node in a normal replication process continues. It means that the old database is still used by the data clients and is being updated with the normal replication updates, while the new database is being populated with the data received through the synchronization procedure. The method can further include the step of terminating the new replication task instance and deleting an old database at the standby node upon completion of the synchronization. At this point, all the data region clients dynamically switch to use the new database. When a critical failure occurs during synchronization, the method can further include the step of switching over from the active node to the standby node to serve as the active node and assume the functionality of the active node. The method can further continue synchronization using the standby node or peer node serving as the active node by applying any remaining data to the new database region while continuing to use an old version of a database at the peer node. If the source code has an unrecoverable failure during synchronization, the peer node uses the new replication task instance to synchronize at least a portion of a new database region with an old database region at the peer node. Once the synchronization between at least the portion of the new database region and the old database region is complete, the new replication task is terminated and the new database region is destroyed.

In a second embodiment of the present invention, a task controller in a highly available communication system having at least a source node and a peer node can include a logical unit programmed to control the process of forwarding data changes to the peer node from the source node, monitor a health status of a replication task by performing an audit on the source node and the peer node, and compare the audit on the source node with the audit on the peer node. The logical unit can be further programmed to initiate synchronization upon determining an out of synchronization status causing the launching of a new replication task instance for synchronization purposes of a new database region at the peer node and the populating of the new database region with data from a source database from the source node. The logical unit can also further be programmed to terminate the new replication task instance and delete an old database at the standby node upon completion of the synchronization. Note, the logical unit can be hardware (such as a microprocessor or controller or several processors serving as a node) or software for performing the functions described.

In a third embodiment of the present invention, a communication system can include a source node coupled to a peer node in a dual-node replication environment, a source database at the source node and a target database at the peer node, and a logical unit. The logical unit can be programmed to control forwarding data changes to the peer node from the source node, monitor a health status of a replication task by performing an audit on the source node and the peer node, and compare the audit on the source node with the audit on the peer node. The logical unit can be further programmed to perform at least one among the functions of synchronizing the source database with the target database by launching a replication task synchronization thread and a new target database at the peer node and replacing the target database with the new target database upon completion of the synchronizing or switching over to the peer node as an active node assuming the functions of the source node upon detection of a critical failure at the source node during synchronization.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is block diagram of a radio communication system in accordance with an embodiment of the present invention.

FIG. 2 is a block diagram of a system including a task controller and a task unit in accordance with an embodiment of the present invention.

FIG. 3 is a block diagram illustrating a basic operation of a task controller in a dual-node data replication environment in accordance with an embodiment of the present invention.

FIG. 4 is block diagram illustrating a task controller performing database audits to ensure data integrity or data region health in accordance with an embodiment of the present invention.

FIG. 5 is block diagram illustrating a task controller initiating data synchronization in accordance with an embodiment of the present invention.

FIG. 6 is block diagram illustrating the task controller of FIG. 5 completing the synchronization process in accordance with an embodiment of the present invention.

FIG. 7 is a block diagram illustrating a task controller handling a critical failure during a synchronization process in accordance with an embodiment of the present invention.

FIG. 8 is a block diagram illustrating a task controller implementing a recovery process at a peer node during an unrecoverable failure at a source node in accordance with an embodiment of the present invention.

FIG. 9 is a flow chart illustrating a method in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein extend the functionality of the task controller disclosed in U.S. Pat. No. 6,286,112 B1 to accommodate database failures in the fault tolerant systems. Systems designed with a task controller as contemplated herein can preserve services and functionality through database failures and can optionally automatically recover lost data in an efficient manner. Although the embodiments disclosed are dual-node system architectures, embodiments herein can be used in single node as well as dual-node system architectures designed to synchronize, refresh, and upgrade data & databases storages (in memory as well as on disk). Further, embodiments herein can maintain the health and consistency of replicated data as well as eliminate outages associated with failures during a synchronization process itself.

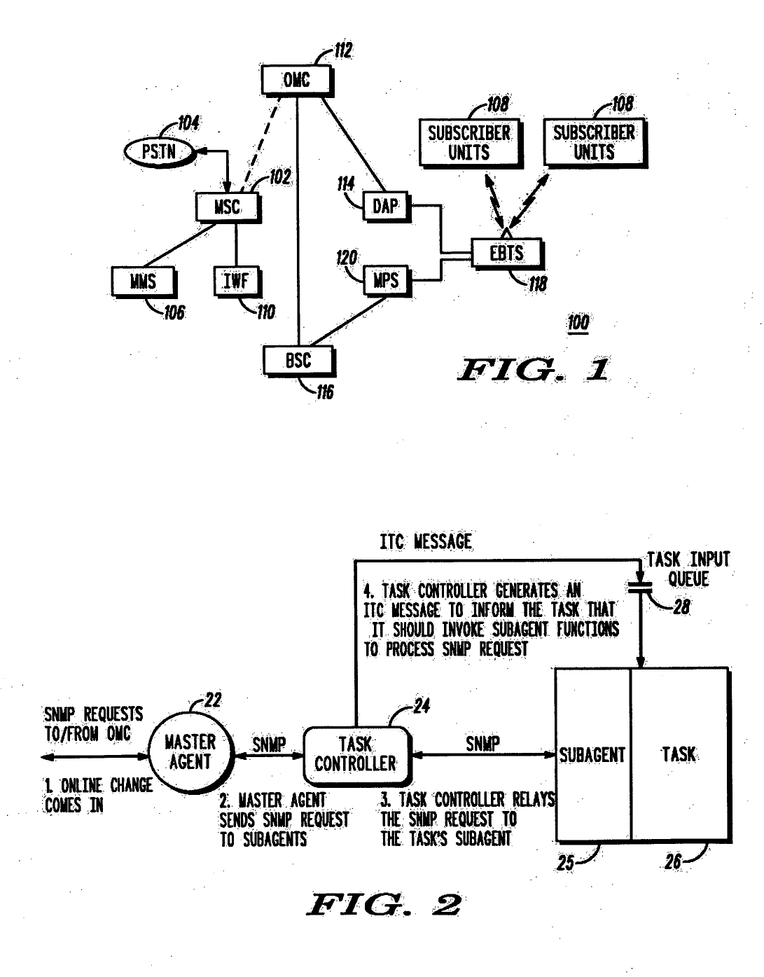

Referring to FIG. 1, a block diagram shows a general system configuration of a telecommunications system 100 in accordance with an embodiment of the present invention. Although such system can be implemented in any number of telecommunications systems, the following discussion will be generally directed to use of a particular embodiment in a wireless “iDEN” system developed by and commercially available from Motorola, Inc. of Schaumburg, Ill. A more detailed discussion of the “iDEN” system may be found in commonly assigned U.S. Pat. No. 5,901,142, entitled “Method and Apparatus for Providing Packet Data Communications to a Communication Unit in a Radio Communication System” and commonly assigned U.S. Pat. No. 5,721,732, entitled “Method of Transmitting User Information and Overhead Data in a Communication Device having Multiple Transmission Modes”, the disclosures of which are hereby incorporated by reference. Embodiments herein can be implemented in any system controlled by software, such as manufacturing systems, medical systems and the like.

The system 100 embodied as an iDEN system can include a mobile switching center (MSC) 102 that provides an interface between the system 100 and a public switched telephone network (PSTN) 104. A message mail service (MSS) 106 connected to the MSC 102 stores and delivers alphanumeric text messages which may be transmitted to or received from subscriber units 108. An interworking function (IWF) system 110 interworks the various devices and communications in the system 100.

An operations and maintenance center (OMC) 112 provides remote control, monitoring, analysis and recovery of the system 100. The OMC 112 can further provide basic system configuration capabilities. The OMC 112 is connected to a dispatch application processor (DAP) 114 which coordinates and controls dispatch communications within the system 100. A base site controller 116 controls and process transmissions between the MSC 102 and cell sites, or an enhanced base transceiver system (EBTS) 118. A metro packet switch (MPS) 120 provides one to many switching between the DAP 114 and the EBTS 118. The EBTS 118 is also directly connected to the DAP 114. The EBTS 118 transmits and receives communications with the subscriber units 108. As will be further detailed below, a task controller 24 as shown in FIG. 2 that can be resident in the DAP 114 or in another type processor can provide functionalities of data region health monitoring, online database recovery or replacement, and synchronization failure recovery in accordance embodiments of the present invention will.

The task controller 24 as shown in FIG. 2 communicates preferably through a Simple Network Management Protocol (SNMP) to a master agent 22 and a subagent 25 associated with a task 26. The DAP 114, for example, may have a single master agent which is associated with one or more tasks. The master agent 22 typically communicates with the OMC 112 on one side, and a subagent on the other side. Preferably, each task associated with a master agent has a designated subagent and task controller.

In operation, an online change request, or configuration information, from the OMC 112 is received by the master agent 22. This configuration information can be in any appropriate format, such as an ASN-1 encoded configuration file. In response thereto, the master agent 22 parses the configuration information and builds requests in SNMP format for the different subagents. During registration, each subagent identifies to its associated master agent the portion of the configuration for which it is responsible. The master agent 22 then sends the appropriate request, or subagent message, preferably in SNMP format, to the task controller 24 which is addressed to the proper subagent, such as the subagent 25. The task controller 24 detects the subagent request and in response, generates an ITC message. The ITC message contains information sufficient to inform the task 26 of the incoming subagent request and that the task 26 should invoke subagent functions to process the subagent request. The task controller 24 can also relay the subagent request to the subagent 25 associated with the task 26.

The master agent 22, which may be located at the DAP 114 thereby controls the task controller 24 which, in turn, controls the task 26. The OMC 112 may contain a OMC master agent which controls the operation of the DAP master agent 22. For example, the OMC master agent may send upgrade information/procedures to the DAP master agent 22. These upgrade procedures will typically contain the possible failure scenarios and the recovery procedures for each scenario. As will be readily understood by those skilled in the art, the description herein is directed to a specific implementation having a particular structure and element configuration for clarity and ease of description, however, embodiments herein can be employed in numerous structures and element configurations. For example, the master agents may be located in different structures and have different capabilities than those described herein.

The ITC message is stored in a task input queue 28 until accessed by the task 26. When the task 26 accesses the ITC message, the task 26 will invoke subagent functions to read and parse the subagent message. An output of the task 26 is sent to a task output queue (not shown). The task controller 24 thus analyzes and controls the operation of the task 26. The task 26, the task input queue 28 and the task output queue comprise a task unit for performing certain tasks. The task input and output queues, the subagent 25 and the task 26 comprise a task unit.

In another aspect of the embodiments herein, the SNMP protocol and socket connections can be used to relay configuration messages from a Network Manager to a Network Element (such as the OMC). Since most of the box tasks are queue-based and event-triggered, an entity such as the task controller 24 can inform (or relay to) a task that an SNMP Master Agent has some configuration information for the task. As noted above, the task controller functions can include forwarding SNMP messages from Master Agent 22 to the Tasks' SubAgent 25 and back to Master Agent 22, generating a message and sending it to the task's incoming message queue 28 to inform it about an incoming SNMP packet every time the task controller 24 forwards an online SNMP request to the task's listening port. In this regard the task controller 24 can generate an ITC message to inform the task 26 that it should invoke SubAgent functions to process SNMP requests. As soon as the task 26 receives the message generated by the Task Controller 24, the task controller 24 will invoke subagents functions to read and parse the received SNMP request(s).

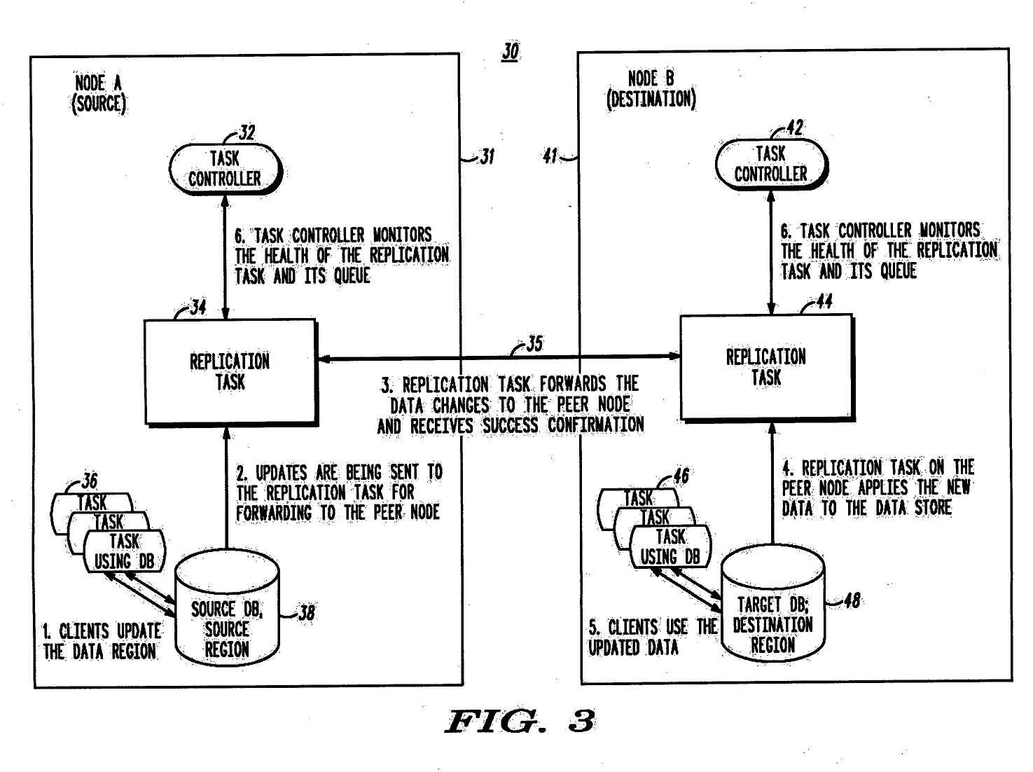

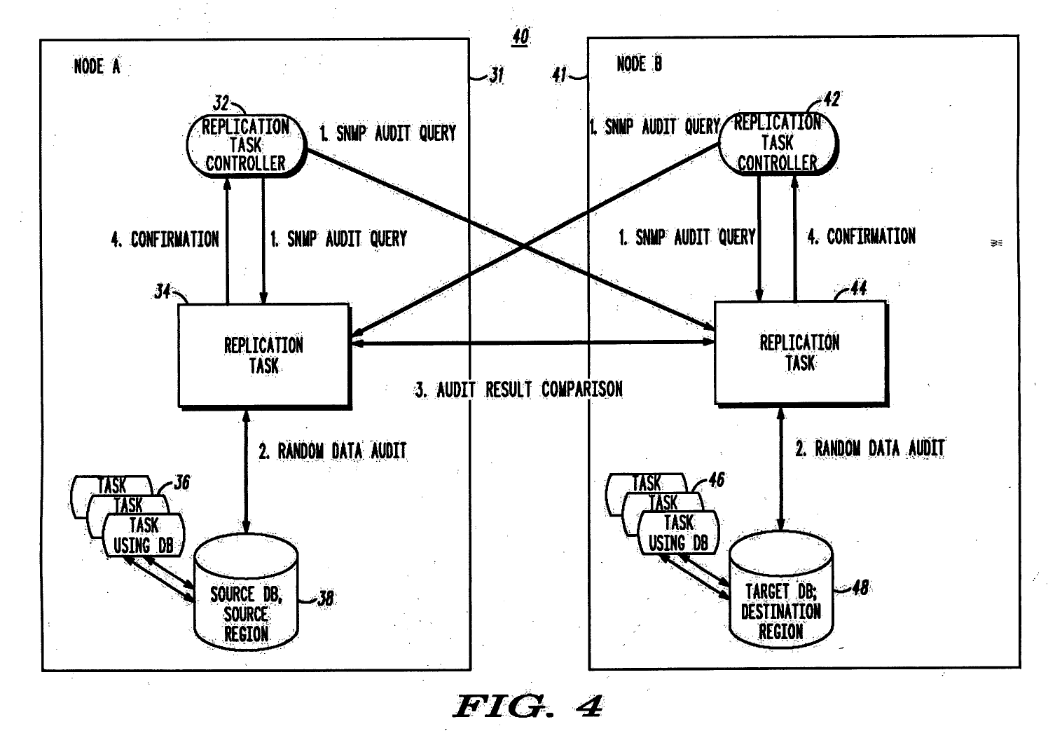

The task controller as will be seen in FIGS. 3-8 extend the functionality of the task controller introduced in U.S. Pat. No. 6,286,112 B1 from a simple relaying entity into a complex controlling mechanism which has power to analyze and control the task's behavior. The existing functionality included Task Initialization, Regular Task Controller Functionality, Automatic online task/queue replacement, Manual online task replacement, and Task Controller replacement. Such existing task controller did not address the monitoring, recovery, or replacement of data regions, which becomes vital with farther development of highly available systems. One of the methods widely used to achieve fault tolerance is to use dual-node configurations, where two nodes act as a pair in an active-standby or an active-active configuration. If a failure is experienced on a single node, the other node automatically takes on the failed node functionality. Of course, recovery of the failed node should be done as soon as possible. A bi-nodal configuration can be subject to additional requirements that introduce new possibilities of failures. For example, if a system contains a database which is updated during run-time, the updates need to be replicated to the other node, such that in case of a switchover, the new active node's database has the latest data. The task controller functionality herein can be extended to accommodate such new responsibilities of monitoring the database health and replication functionality. At the same time, the Task Controller needs to take into account that while a task is being replaced, it is not updating its data stores. Thus, once the online task replacement is completed, the data stores should be synchronized in accordance with embodiments of the present invention. Therefore, a task controller in accordance with the embodiments herein can monitor the health of a data region, provide for online database recovery and online database replacement, and further provide synchronization failure recovery.

Referring to FIGS. 3-8, further details of task controller functionality in a dual-node replication environment will be explored. In the environment of FIG. 3 such as a dual-node fault tolerant system 30, a Task Controller 32 at a source node 31 and a task controller 42 at a peer node 41 monitors the functionality of a Replication Task 34 or 44 respectively, which, in turn, is responsible for the data replication and synchronization between the nodes of the system 30. In the normal replication scenario, the data region 38 on source node 31 (A) can be updated by clients 36 in a first step (1). These updates can be sent to the Replication Task in a second step (2), which, in turn, forwards the information to the peer node in a third step (3) or step 35. The Replication Task 44 on Node 41 (B) applies the changes to the data store 48 during a fourth step (4) and new data can be used by the client tasks 46 on Node 41 in a fifth step (5). While the functions above take place, the Task Controller (32 and/or 42) can monitor the health of the Replication Task (34 and/or 44) and its queues during a sixth step (6).

Referring to FIG. 4, a system 40 similar to system 30 of FIG. 3 can include the Task Controller 32 or 42 that also monitors the health of the Data Regions by performing random Database Audits. The Task Controller (32 or 42) on each node can probe the Replication Task (34 or 44) for the audit on both its own and on the peer node via SNMP queries in a first step (1). The Replication Task executes a random audit (checking both the Data Stores (38 or 48) themselves as well as the replication queues which may contain still unapplied data in a second step (2) and compares audit results between the nodes at a third step (3). The confirmation is sent back to the Task Controller via SNMP in a fourth step (4).

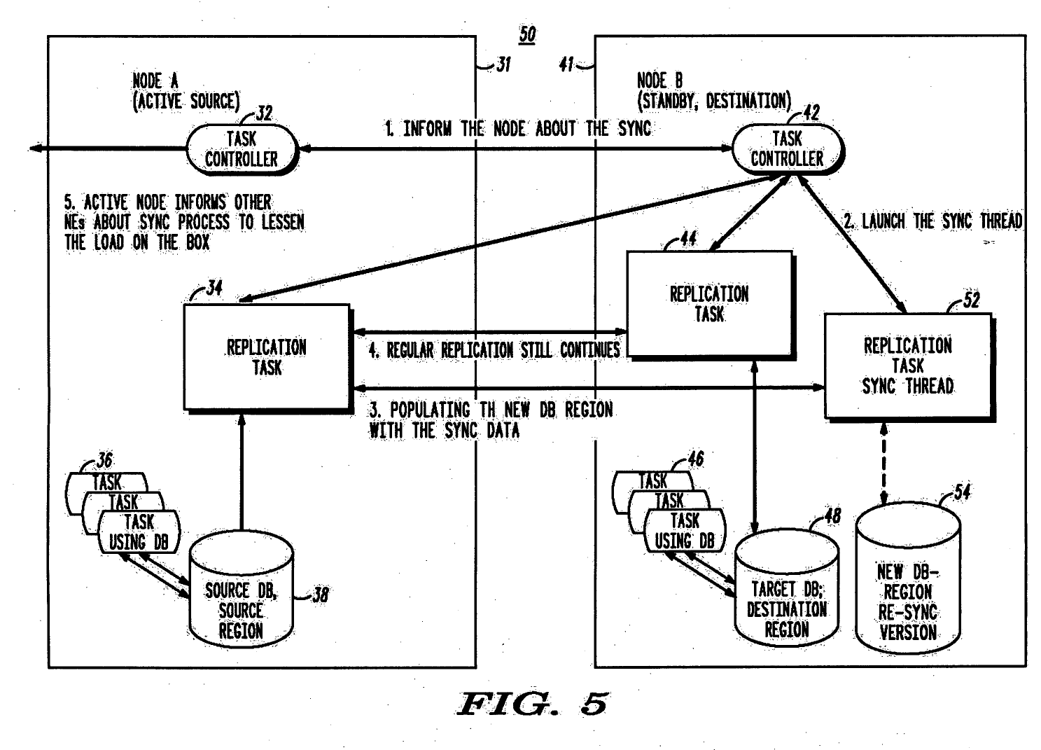

Referring to FIG. 5, a system 50 (similar to systems 30 and 40) can include a Task Controller (32 or 42) that processes confirmations as explained above and in case of data being out-of-synchronization, initiates a data region synchronization. In the case of an Active-Standby dual node configuration as shown, the Standby node (41) will be performing the actions (so the Active node (31) does not bear the additional performance impact). The Task Controller 42 informs the other node (31) about a synchronization procedure being initiated at a first step (1) and also launches a new Replication Task thread/instance 52 for the synchronization purposes in a second step (2). The Replication Task 34 on the Active node 31 starts sending the data from the Source database or data store 38 to the Standby Node 41. The data is received by the Sync Thread 52 on the Standby node 41 and a new database region 54 becomes populated in a third step (3). Note, that while the synchronization is in progress, the normal replication due to the new updates continues through regular replication channels as shown in step (4). All the data clients are still connected to the old database. In a fifth step (5), the task controller 32 in the active node 31 can inform other peer nodes about the synchronization process to reduce the load on the nodes that are synchronizing. Note, there can be other conditions to initiate the synchronization procedure such as a database lost on initialization, a data corruption during run-time, or a customer manually initiating the procedure. In these conditions, the Task Controller will perform the procedure as described above.

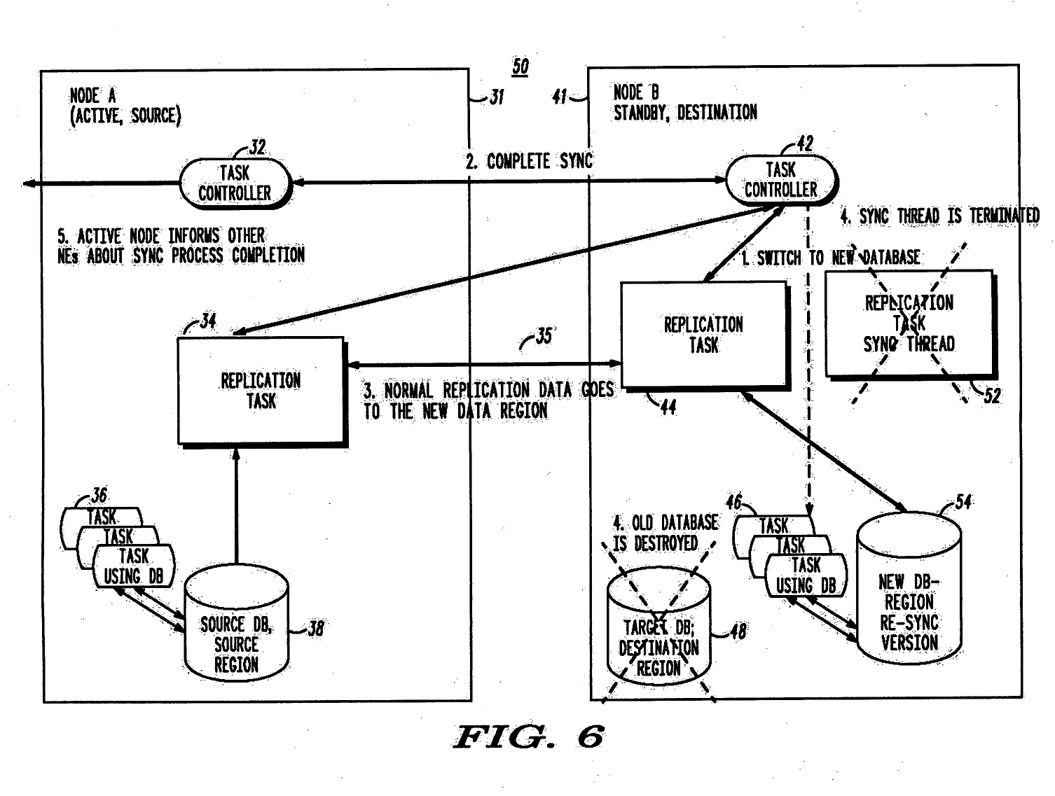

Once the whole data region has been synchronized, the Task Controller 42 on the Standby Node 41 completes the procedure sending the SNMP notifications to the Replication Task and to the Client Task to start using the newly populated Database at a first step (1) as shown in FIG. 6. Afterwards, the Task Controller 42 informs the other node 31 about the procedure completion at a second step (2). The normal replication process will use the new database at this point in a third step (3). At the end of the procedure, the Task Controller 42 terminates the Replication sync thread 53 and destroys the old database 48 during a fourth step (4). At this point, all data clients dynamically switch to use the new database.

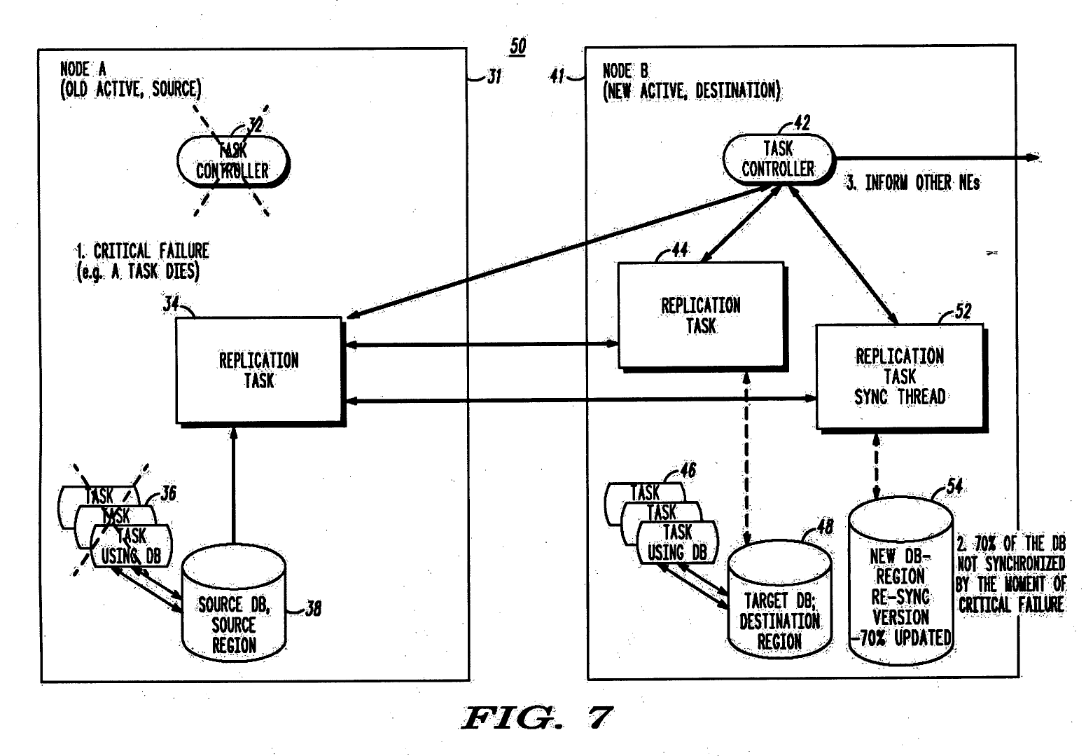

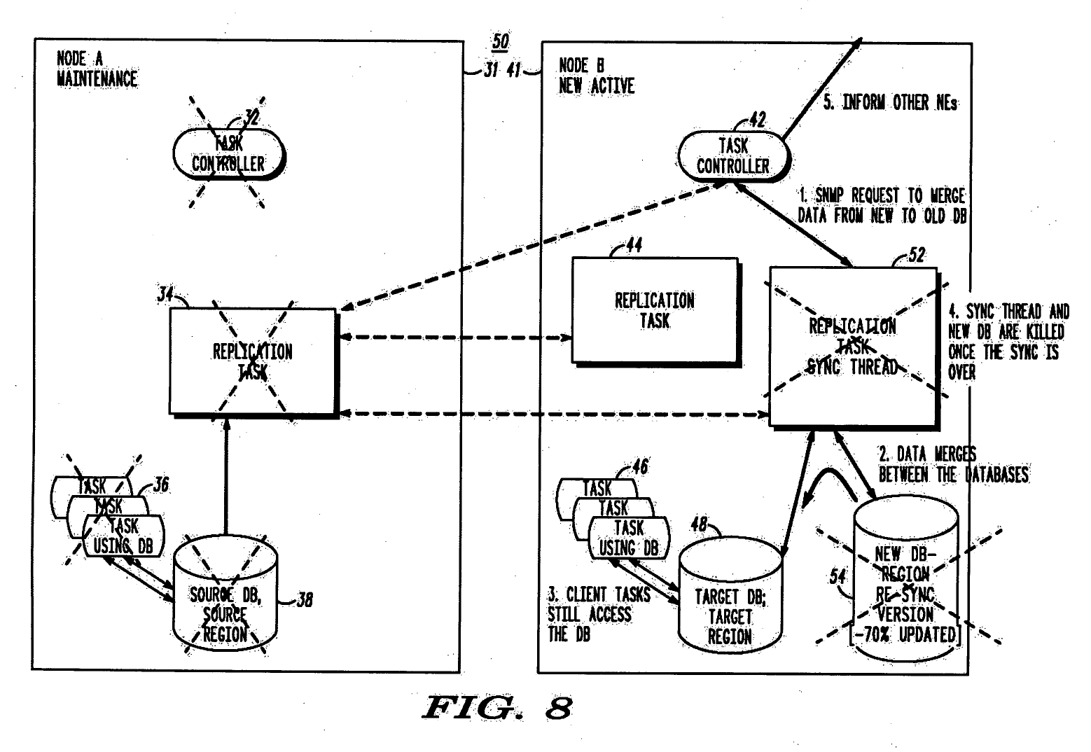

Referring to FIGS. 7 and 8, a block diagram illustrating how the system 50 can gracefully handle and recover from a failure that occurs while the synchronization is in progress to recover both the functionality and the lost data. Whenever a critical failure occurs on a bi-nodal system, a switchover will take place enabling the new active node 41 to assume functionality of the old active node 3 1. However, the interrupted synchronization procedure should continue, if possible, or other measures must be taken to ensure data consistency.

As illustrated in FIG. 7, a critical failure occurs on Node 31 which used to be an Active Node while the synchronization was taking place during a first step (1). At this point, a certain percentage (assume 70%) of the database got replicated at a second stage (2). A switchover takes place from Node 31 to Node 41 and the Node 41 becomes the new Active Node. If the Node 31 recovers (after a restart or other recovery procedure), Node 41 continues the synchronization procedure by applying the remaining data to the new database 54 while using the old version of the database 48 as described above. At the same time, the new data changes on Node 31 are being replicated to Node 41 through the normal replication process.

Referring to FIG. 8, the scenario where the failed node (31) does not recover from failure is shown. In such instance, the fault tolerant system 50 has to run with only one node available. The synchronization procedure cannot continue at this point, so the Task Controller 42 on the new Active node (41) has to ensure the system 50 runs with the latest data available. Assuming the new database 54 has accumulated a large percentage of the changes before the critical failure occurred, the new database 54 contains the latest data available on the node 41 and the Task Controller 42 instructs the Sync Thread 52 via an SNMP request to merge the latest data from the new database 54 to the old database 48 (which is still in use by the client tasks 46 in a first step (1). The Sync thread 52 begins synchronizing the databases at a second step (2), while the client task still accesses the old database at a third step (3) which eventually gets updated with the latest information available. Once the synchronization between the databases is complete, the new database 54 as well as the Sync thread 52 are destroyed in a fourth step (4). The task controller 42 will also inform other peer nodes in a fifth step (5) to reduce the burden on the node 41 while the original source node 31 remains un-recovered. From this point on, the node 41 will function until the other node 31 recovers. Once the connection with the peer node is available, the Task Controller (32 or 42) checks if the synchronization is necessary and restores the normal functionality of the system.

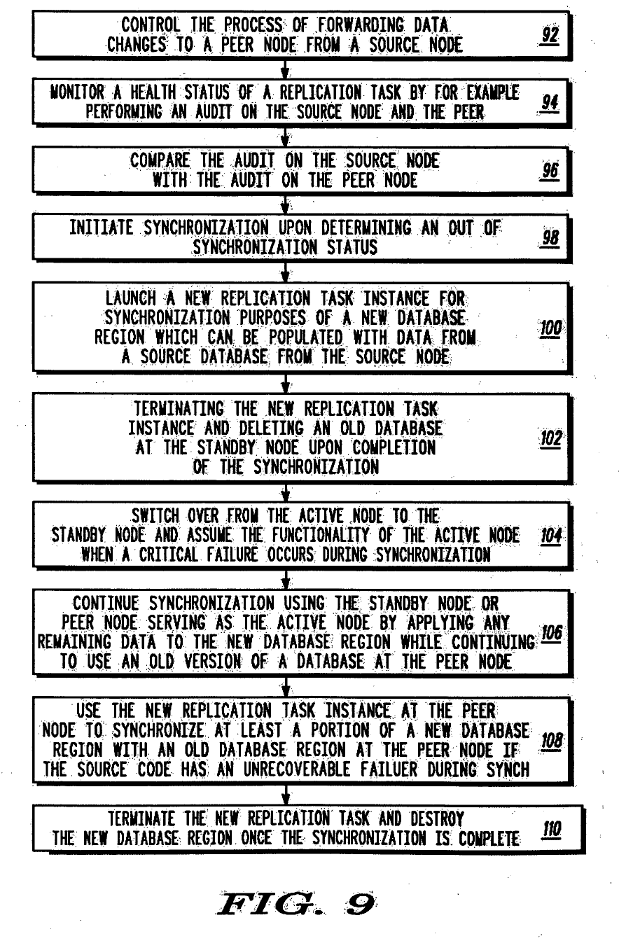

Referring to FIG. 9, a flow chart illustrating a method 90 for task controller operation in a multi-nodal replication environment in a communication system. The method 90 can include the step 92 of controlling the forwarding of data changes to a peer node from a source node, monitoring a health status of a replication task at step 92 by (for example) performing an audit on the source node and the peer node, and comparing the audit on the source node with the audit on the peer node at step 94. Monitoring can also be done by or include performing the audits on the source node and peer node using SNMP queries and can also be done by executing a random audit by a replication task that checks data stores at the source node and at the peer node. Note, the random audit can further include checking replication queues. As a result of the monitoring, confirmations can be sent back to the task controller using SNMP for example.

The method 90 can further include the step 98 of initiating synchronization upon determining an out of synchronization status. Synchronization can be initiated by one among a detection of a lost database on initialization, a detection of data corruption during run-time, and a user selected initiation as examples. Note, a task controller in an active-standby dual node configuration can enable a standby node among the source node and the peer node to process synchronization to reduce overhead on an active node. During synchronization, the method 90 can further include the step 100 of launching a new replication task instance for synchronization purposes of a new database region which can be populated with data from a source database from the source node. Further note, the synchronization process can occur between the source node and the standby node while the step of forwarding data changes to the peer node from the source node in a normal replication process continues. The method can further include the step 102 of terminating the new replication task instance and deleting an old database at the standby node upon completion of the synchronization. When a critical failure occurs during synchronization, the method 90 can further include the step 104 of switching over from the active node to the standby node to serve as the active node and assume the functionality of the active node. The method 90 can further continue synchronization at step 106 using the standby node or peer node serving as the active node by applying any remaining data to the new database region while continuing to use an old version of a database at the peer node. If the source code has an unrecoverable failure during synchronization, the peer node uses the new replication task instance to synchronize at least a portion of a new database region with an old database region at the peer node at step 108. Once the synchronization between at least the portion of the new database region and the old database region is complete, the new replication task is terminated and the new database region is destroyed at step 110.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method for task controller operation in a multi-nodal replication environment in a communication system, comprising the steps of:
controlling forwarding data changes to a peer node from a source node;
monitoring a health status of a replication task by performing an audit on the source node and the peer node;
comparing the audit on the source node with the audit on the peer node; and
supervising continuous data replication and initiating a dynamic data recovery when failures are detected.

2. The method of claim 1, wherein the step of monitoring is done by performing the audits on the source node and peer node using SNMP queries.

3. The method of claim 1, wherein the step of monitoring further comprises the step of executing a random audit by a replication task that checks data stores at the source node and at the peer node.

4. The method of claim 3, wherein the step of executing the random audit further comprises the step of checking replication queues.

5. The method of claim 1, wherein the method further comprises the step of sending a confirmation back to the task controller using SNMP.

6. The method of claim 1, wherein the method further comprises the step of initiating synchronization upon determining an out of synchronization status.

7. The method of claim 6, wherein the method at a task controller in an active-standby dual node configuration enables a standby node among the source node and the peer node to process synchronization to reduce overhead on an active node.

8. The method of claim 6, wherein the method further comprises the step of launching a new replication task instance for synchronization purposes of a new database region.

9. The method of claim 8, wherein the method further comprises the step of populating the new database region with data from a source database at the source node.

10. The method of claim 1, wherein the method further comprises the step synchronization between the source node and the standby node while the step of forwarding data changes to the peer node from the source node in a normal replication process continues.

11. The method of claim 6, wherein the step of initiating synchronization is initiated by one among a detection of a lost database on initialization, a detection of data corruption during run-time, and a user selected initiation.

12. The method of claim 9, wherein the method further comprises the step of terminating the new replication task instance and deleting an old database at the standby node upon completion of the synchronization wherein all data clients dynamically switch to use a new database at the new database region.

13. The method of claim 8, wherein the method further comprises the step of switching over from the active node to the standby node to serve as the active node and assume the functionality of the active node when a critical failure occurs during synchronization.

14. The method of claim 13, wherein the method further comprises the step of continuing synchronization using the standby node or peer node serving as the active node by applying any remaining data to the new database region while continuing to use an old version of a database at the peer node.

15. The method of claim 8, wherein if the source code has an unrecoverable failure during synchronization, the peer node uses the new replication task instance to synchronize at least a portion of a new database region with an old database region at the peer node.

16. The method of claim 15, wherein once the synchronization between at least the portion of the new database region and the old database region is complete, the new replication task is terminated and the new database region is destroyed.

17. A task controller in a highly available communication system having at least a source node and a peer node, comprising:
a logical unit programmed to:
forward data changes to the peer node from the source node;
monitor a health status of a replication task by performing an audit on the source node and the peer node; and
compare the audit on the source node with the audit on the peer node.

18. The task controller of claim 17, wherein the logical unit is further programmed to initiate synchronization upon determining an out of synchronization status causing the launching of a new replication task instance for synchronization purposes of a new database region at the peer node and the populating of the new database region with data from a source database from the source node.

19. The task controller of claim 18, wherein the logical unit is further programmed to terminate the new replication task instance and delete an old database at the standby node upon completion of the synchronization.

20. A communication system, comprising;
a source node coupled to a peer node in a multi-node replication environment,
a source database at the source node and a target database at the peer node;
a logical unit programmed to:
forward data changes to the peer node from the source node;
monitor a health status of a replication task by performing an audit on the source node and the peer node;
compare the audit on the source node with the audit on the peer node; and
wherein the logical unit is further programmed to perform at least one among the functions of:
synchronizing the source database with the target database by launching a replication task synchronization thread and a new target database at the peer node and replacing the target database with the new target database upon completion of the synchronizing; and
switching over to the peer node as an active node assuming the functions of the source node upon detection of a critical failure at the source node during synchronization.
